(19) United States
(12) Patent Application Publication
(10) Pub. No.: US 2011/0293904 A1
(43) Pub. Date: Dec. 1, 2011

(54) METHOD FOR MANUFACTURING A SURFACE ELEMENT

(75) Inventor: Patrick George Smith, Raleigh, NC (US)

(73) Assignee: Pergo AG

(21) Appl. No.: 12/788,844

(22) Filed: May 27, 2010

(51) Int. Cl. B29C 39/12

(52) U.S. Cl. 428/201; 264/246

(57) ABSTRACT

The invention concerns a method for manufacturing a surface element (1), especially a floor panel, with a supporting core (2) and a surface (4) to be imprinted, comprising the following steps:
impregnating the surface (4) to be imprinted with a dyed resin or application of printing ink (5) onto the surface (4) to be imprinted for creation of a decorative pattern,
attaching a pressing tool (10) and application of pressure onto the surface element (6), with a redistribution of printing ink (5) or dyed resin occurring alongside the surface (4) to be imprinted depending on a structure (11, 12) of the pressing tool (10), so that a colour saturation is influenced at least of areas of the decorative pattern.

The invention relates to a method for manufacturing a surface element, especially a floor panel.

EP 1 153 736 B1 relates to a method for manufacturing a decorative, thermosetting laminate with a surface structure in line with the imprinted decorative pattern. In this process a structured foil or a hardboard is used having a number of surface structure sections. Positioning means are provided by means of which a desired matching between the decorative pattern and the surface structure is obtained. Especially in the case of a fine decorative pattern, matching with the surface structure is difficult.

It is the problem of the present invention to provide an improved method for manufacturing a surface element. This problem is typically solved by a method for manufacturing a surface element, especially a floor panel with a supporting core and a surface to be imprinted, comprising the following process steps: impregnating the surface to be imprinted with a dyed resin or applying of printing ink onto the surface to be imprinted for creation of a decorative pattern, attaching a pressing tool and application of pressure onto the surface element. The inventive method is most often characterised by the fact that as a function of a structure of the pressing tool, the printing ink or dyed resin along-side the surface to be imprinted is redistributed so that a colour saturation at least of areas of the decorative pattern can be influenced. Advantageously, selective influencing of colour saturation can be obtained. As used in this paragraph, it is understood that the printing ink described or used elsewhere herein, can be replaced with a dyed or coloured resin.

Within the scope of the invention, colour saturation represents a measure for the amount of colour attributed to a certain unit area with more colour being attributed to the unit area in the case of a high colour saturation than in the case of a lower colour saturation. Colour saturation may be formed by a ratio out of colour weight and unit area or colour layer thickness and unit area.

By redistribution of the printing ink or the dyed resin as a function of the structure, the decorative pattern can be directly produced by the structure which may result in an improved matching of graphic and structural pattern. Moreover, manufacture of such surface elements can be simplified, since by the production of decorative pattern sections and structural pattern sections in one step the use of separate positioning means can become superfluous or these might be formed in a simpler way. Redistribution of printing ink or dyed resin typically occurs in this process alongside the surface to be imprinted, i.e., that the printing ink or the dyed resin can flow substantially in the plane of the surface to be imprinted. The direction of movement of the printing ink or the dyed resin can preferably be perpendicular to a pressing direction of the pressing tool. In this process, the pressing tool can exert pressure on the printing ink or the dyed resin so that in particular printing ink or dyed resin from areas of higher pressure can be moved into areas of lower pressure. The pressing tool can be placed directly onto the surface to be imprinted and/or the printing ink or the dyed resin, i.e., that also at least another layer, in particular a wear protection layer, can be arranged between the pressing tool and the surface to be imprinted and/or the printing ink or the dyed resin. But the wear protection layer, however, needs not necessarily become a part of the surface element. In order that a redistribution of printing ink or dyed resin on the surface to be imprinted is possible, the surface to be imprinted can be non-absorbing with respect to the printing ink or the dyed resin used.

In a first preferred embodiment it is provided that printing ink or dyed resin is applied in a defined way on separate areas of the surface to be imprinted with the decorative pattern in individual areas of the surface to be imprinted being selectively influenced by the redistribution of printing ink or dyed resin. In this process, printing ink or dyed resin is applied preferably in the separate areas, which can have a diameter from some micrometers up to some centimeters, whereas adjacent areas can comprise printing ink or dyed resin of another colour shade or no colour at all. In border areas between two different areas a selective mixing of printing ink or dyed resin may occur.

In a second preferred embodiment the surface to be imprinted can be substantially homogeneously coated with printing ink or dyed resin. A non-homogeneous decorative pattern can then be created exclusively by redistribution of printing ink or dyed resin. Especially in the case of this embodiment it may occur that alignment means for pressing tool alignment to the decorative pattern can be entirely omitted. The decorative pattern is then preferably produced entirely by the pressing tool structure. As a result, a surface element can be produced which substantially can comprise a precise matching between decorative pattern and structural pattern.

For both embodiments it is preferred that a wear protection layer is applied to the surface to be imprinted and to the printing ink or the dyed resin applied. The wear protection layer can comprise a curable resin, especially a resin curable under heat or pressure, which moreover can be provided with particles which can increase wear resistance of the wear protection layer. Such particles can for example be formed from aluminium oxide.

Preferably the printing ink or the dyed resin is applied directly onto the surface to be imprinted. The resin carrier or surface to be imprinted is preferably non-absorbing with respect to the printing ink or the dyed resin. A non-absorbing surface with respect to the printing ink or the dyed resin is a surface where a fixation of the printing ink or the dyed resin on the surface or in the material forming the surface is not readily possible or possible only in an insignificant way. Colour particles are then in particular not only held by a fabric forming the surface. After application of the printing ink or the dyed resin on the surface, a largely residue-free flowing of the printing ink or the dyed resin on the surface can still be possible. For a fixation of the printing ink or the dyed resin on the surface to be imprinted—so that a decorative pattern can be permanently maintained—at least one another step is then necessary. The surface to be imprinted can be provided by the supporting core or by a separate intermediate layer.

Suitable core materials may include one or more of wood, particleboard, fiberboard, such as high density fiberboard (HDF) or medium density fiberboard (MDF); polymer (thermosetting and thermoplastic, and in a solid, sheet or corrugated form) and especially phenolic laminate; flaxboard, stone (e.g., ceramic, marble, slate), cardboard, concrete, gypsum, high density fiber reinforced plaster, plywood, oriented strand board, cores made from cellulosic particles (including discrete pieces of wood, which can be veneers, chips, curls, flakes, sawdust, shavings, slivers, stands, wafers, wood flour, wood wool and/or wood fibers) bonded together by an organic or inorganic binder; and other structural materials, such as metals (e.g., brass, aluminum, steel, copper, composites or alloys). In some embodiments, the core material can be foamed (either open cell or closed cell), such as polyurethane, and can be virgin or may include a recycled portion. In still further embodiments, the core is made from multiple materials (such as those listed above), either as a heterogeneous mass, multiple layers or defined sections. In some embodiments, it is desirable, e.g., for acoustic, footfall impact or other reasons to include a damping foil of an elastomer arranged between the core and the upper and/or lower decorative surface. Suitable elastomer materials are described in U.S. Pat. No. 6,893,713, the entire disclosure of which is herein conventional by reference. A particularly preferred laminate is made from a core of phenolic resin impregnated papers, otherwise known as compact laminate, onto which each of the upper and lower decorative surfaces is also laminated. A dampening foil or foils may also be included in such an embodiment. The entire compact laminate, including the decorative laminate, and any dampening foils can be made in one step in a EL press. Any of the above materials, such as the core and decorative layers, may also be provided with antistatic or antibacterial properties, e.g., by the inclusion of silver flakes, powders or particles, organic antibacterial compounds, carbon black, ceramics, or other metals or alloys. Preferred plastics include extrudable and/or moldable thermosetting and thermoplastic resins, the latter including high density olefins and polyvinylchloride, and the former including phenolics, such as phenol-formaldehyde and UV or radiation curable resins, such as melamine based resins, e.g., melamine formaldehyde.

Preferably a printing ink or a dyed resin substantially free from binders is used which means in particular that the printing ink or the dyed resin after application continues to be free-flowing. A curable resin, which might accommodate colouring pigments, is considered to be a binder within the scope of the present invention. By using printing ink or dyed resin without binders, an improved redistribution of the printing ink or the dyed resin on the surface to be imprinted can result.

Preferably, the pressing tool comprises pressing tool sections with elevations and pressing tool sections with recesses with the pressing tool sections with elevations being able to create an escape of printing ink or dyed resin on corresponding areas of the surface to be imprinted alongside the surface to be imprinted. The elevations on the pressing tool sections can locally exert an increased pressure on the printing ink or the dyed resin so that printing ink or dyed resin is charged in areas of minor pressure load and can escape there. Insofar a lower colour saturation or increased transparency may occur in such areas. The areas of lower colour saturation can then be automatically aligned with recesses on the structural pattern.

Preferably, pressing tool sections with recesses produce a minor escape of printing ink or dyed resin on corresponding areas of the surface to be imprinted than pressing tool sections with elevations. Insofar in such areas a lower pressure is created on the printing ink or dyed resin so that a minor escape can occur. Alternatively it may also occur that by exerting less pressure of the pressing tool section, printing ink or dyed resin is accommodated which has escaped in other areas of the surface to be imprinted. Therefore, printing ink or dyed resin may accumulate in areas which cooperate with pressing tool sections with recesses.

Preferably a fixation of the printing ink or the dyed resin on the surface to be imprinted occurs exclusively in connection with application of heat and/or pressure, i.e. in particular that prior to application of heat and/or pressure the printing ink or the dyed resin is not fixed, and thus substantially remains capable of flowing. By this it can be selectively determined when fixation of the printing ink or the dyed resin occurs and/or in which process step redistribution of printing ink or dyed resin on the surface to be imprinted remains possible. Preferably the surface to be imprinted is non-absorbing with respect to the printing ink or the dyed resin used.

The invention further relates to a surface element, in particular a floor panel, which is manufactured in accordance with the above mentioned method. The invention further relates to a surface element, in particular a floor panel, comprising a supporting core, a surface to be imprinted, which is applied onto the supporting core at least indirectly with a decorative pattern being applied onto the surface to be imprinted with at least one printing ink or dyed resin. The inventive surface element is characterized by the fact that the surface to be imprinted is non-absorbing with respect to the printing ink or the dyed resin. In the event that several printing inks or dyed resins are used, the surface to be imprinted is preferably non-absorbing with respect to all or most printing inks or dyed resins used. The advantages already mentioned with respect to the process result, in particular since due to the non-absorbing property of the surface to be imprinted a redistribution of the printing ink or the dyed resin can be possible also after application of the printing ink or the dyed resin onto the surface to be imprinted.

Although rectangular (e.g., square) panels are preferred, the panels can independently be of any regular or irregular geometric shape, e.g., octagonal, hexagonal, triangular; see those shown in U.S. Pat. Nos. 6,823,638; 6,854,235; 6,588,166; 6,920,732; 6,763,643; RE39,439; 6,536,178; 6,591,568; 6,601,359; 7,040,068; 7,003,924; U.S. Patent Publication Nos. 2007/0006543 A1; 2006/0099386A1 or International Publication No. WO 2006/043893, each incorporated in its entirety by reference. If the panels are all of the same shape, the dimensions need not be the same, as for example, rectangular panels of varying lengths/widths may be used. When the panels are all rectangular (with one set of long sides and one set of short sides), the long sides are usually joined by relative horizontal movement, but can be joined by relative rotational movement or relative vertical movement or a fold down movement, such as shown in the disclosure of the aforementioned WO 2006/043893 and U.S. Pat. Nos. 6,854,235 and 6,763,643 and U.S. Patent Publication No. 2007/0006543, especially the drawings thereof. Such relative horizontal movement can be a sliding motion along a side, joining only one entire side at once, or joining multiple sides at once, as shown in FIGS. 4-7 of U.S. Pat. No. 6,823,638. The short sides of such panels can also, but need not, be assembled by relative horizontal movement and may lock. The joints can include a slideable or deformable element, or in an alternative, a static element to hold the panels together once assembled, such as shown in the aforementioned WO 2006/043893 publication, and U.S. Pat. Nos. 6,920,732; 6,763,643; 6,729,091; and Patent Publication No. US 2007/0006543 A1.

Preferably, a wear protection layer is applied at least indirectly onto the printing ink or the dyed resin.

The resulting products typically have a durability rating. As defined by the European Producers of Laminate Flooring, such products can have an abrasion resistance rating of anywhere from AC1 to AC6. Typical abrasion resistances are >300 cycles, >400 cycles, >500 cycles, at least 900 cycles, at least 1500 cycles (AC2), at least 2000 cycles (AC3), at least 4000 cycles (AC4), at least 6500 cycles (AC5) and at least 8500 cycles (AC6), as measured by European Standard EN 13329 (Annex E). Typical products according to the invention can also have impact resistance ratings of IC1, IC2, IC3, or IC4, as measured by European Standard EN 13329.

Preferably, the printing ink or the dyed resin is locally fixed exclusively by application of heat and/or pressure.

Preferably, the printing ink or the dyed resin alongside the surface to imprinted is displaced by mechanical pressure. It is possible that the mechanical pressure has been applied by a pressing tool during impressing a structural pattern onto the surface of the surface element.

Preferably, a structural pattern is pressed onto the surface element with substantially a lower colour saturation of the printing ink or the dyed resin existing in areas of structural pattern sections with recesses than in areas of structural pattern sections with elevations. The structural pattern can be pressed onto a wear protection layer which may have been applied at least indirectly on the printing ink or the dyed resin and/or the surface to be imprinted.

Moreover, it is possible to provide the decor with a texture which enhances the pattern of the underlying paper sheet. Such texturing can be created to be “in register” with offset from, or to contrast with the image of the paper sheet. The texture can be selected by the installer to enhance (e.g., match or contrast with) any texture of adjacent or included surfaces. The texture may also be provided on the decor such that features of the texture extend from a flooring element onto and possible completely across the adjacent flooring elements, which texture may, or may not coincide with the underlying decor. Features of the pattern based on stone or wood may include grains, veins, cracks and/or knots, and those of animation and/or fantasy may include details of the faces, such as wrinkled skin, frown marks, details of the eyes, ears, mouth, teeth, hands, fingers, etc. of the animation and/or fantasy patterns.

A laser can be used to etch or cut directly into the core material before any layer is applied thereto, or in the case of providing a visual pattern directly on the core, before the ink or the dyed resin or other pigment is applied. In an alternative, the laser can be used to cut or etch the surface after the visual pattern (e.g., resin-impregnated paper layer, with or without a wear layer thereon or directly printed pattern) has been applied. For example, it is within the scope of the invention to provide the core with the visual decor (e.g., resin-impregnated paper layer or printed pattern), and then etch the texture into the core, before applying any abrasion resistant layer, or provide the abrasion resistant layer before etching or cutting the core. Although less preferred, the texture can be provided by a procedure, e.g., including a mask, whereby an etching material is laid down in a particular pattern and exposure to, e.g., UV-light, IR-light, or radiation or other mechanical, thermal, optical, or chemical stimulus causes the etching material to form the texture in the wear layer, visual pattern layer and/or core. Either one or both sides of the core can be provided with a texture by this method.

In a preferred embodiment the printing ink or the dyed resin can be pigmented. A pigmented printing ink is a printing ink having pigments. Pigments preferably do not come off the surface to be imprinted or do not penetrate into the surface to be imprinted but they can rather deposit on the surface to be imprinted. Pigments can preferably be mechanically removed from the surface to be imprinted.

Preferably, the surface to be imprinted is formed from glass, graphite, plastics or fibers therefrom. These materials can preferably be non-absorbing with respect to the printing ink or the dyed resin used. Moreover, the supporting core can be produced from such a material. Then, the surface to be imprinted can be provided by the supporting core itself.

Preferably, the decorative pattern is bicoloured with a first decorative colour being defined by a primary colour of the surface to be imprinted, and a second decorative colour being defined by printing ink or the dyed resin or pigmented resin. The decorative pattern is then produced in particular by redistribution of the one printing ink or dyed resin. By redistribution a defined colour saturation in different areas of the surface to be imprinted can be produced whereby also different mixed colour shades may have been produced by the first decorative colour and the second decorative colour.

Alternatively, the decorative pattern can be three-coloured or multi-coloured with a first decorative colour being defined by a primary colour of the surface to be imprinted, and a second and at least one other decorative colour being defined by different printing inks or dyed resins. Substantially the main advantages and effects occur which have been described with respect to the bicoloured decorative pattern. By providing further colours also a multi-coloured decorative pattern can be provided. A colour mixture can be produced by the redistribution and the resulting different saturation degrees of the printing inks or dyed resins.

Moreover the characteristics described with respect to the process can also be applied to the surface element and vice versa, insofar as this is technically possible.

The invention is explained more in detail by means of the following figures where

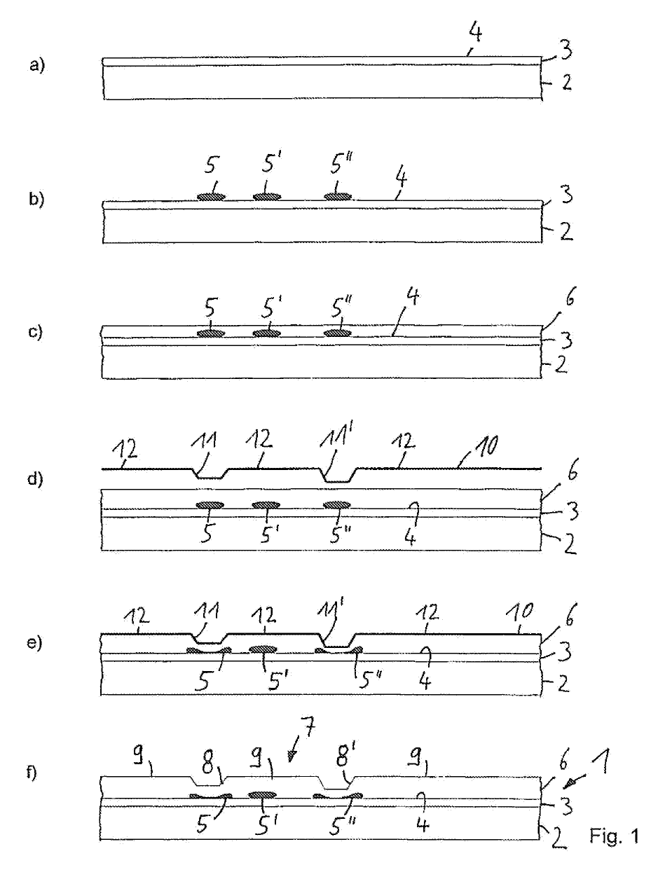

FIG. 1 shows a method for manufacturing a surface element in a first embodiment,

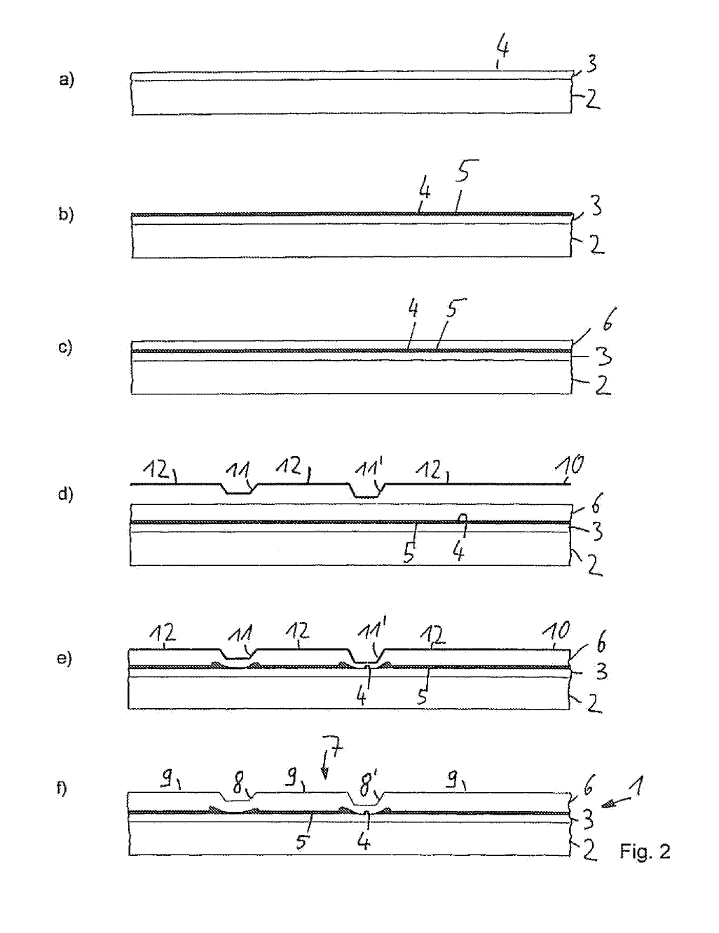

FIG. 2 shows a method for manufacturing a surface element in a second embodiment.

In FIG. 1a a supporting core 2 is shown onto which an intermediate layer 3 is applied in a first process step. The intermediate layer 3 has a surface to be imprinted 4 on its side facing away from the supporting core 2.

In a subsequent process step shown in FIG. 1b defined quantities of printing ink 5, 5′ 5″ are applied on several separate areas of the surface 4 to be imprinted. The surface 4 to be imprinted is non-absorbing with respect to the printing ink used so that a flowing of the printing ink 5, 5′, 5″ on the surface to be imprinted is possible in this process stage. The printing ink may change its position without residues of the printing ink remaining on the surface 4 to be imprinted or only very little residues of the printing ink remaining. The printing ink may, however, have a particularly high surface tension.

In FIG. 1c the next process step is shown where a wear protection layer 6 is applied onto the printing ink 5, 5′, 5″ as well as onto the surface 4 to be imprinted. The wear protection layer 6 in this process step permits a flowing of the printing ink. Likewise, the printing ink is not yet fixed on the surface 4 to be imprinted and thus continues to be capable of flowing.

In FIG. 1d a pressing tool 10 is shown having pressing tool sections with elevations 11 and pressing tool sections with recesses 12. The elevation of pressing tool section 11′ is more pronounced than the elevation of pressing tool section 11 which means that a greater distance of a pressing surface in pressing direction is provided with respect to pressing tool sections with recesses 12 or a reference pressing surface.

In the process step shown in FIG. 1e the pressing tool 10 is now pressed onto the wear protection layer 6 and thus onto the surface element 1. It can be seen that in the area of the pressing tool sections with elevations 11, 11′ an increased pressure is exerted on the wear protection layer 6 and thus on printing ink 5, 5″ than this is the case in the area of the pressing tool sections with recesses 12. By this increased pressure printing ink 5, 5″ is charged in lateral direction so that an escape of printing ink 5, 5″ from these areas of the pressing tool sections with elevations 11, 11′ occurs. It can be seen that in the area of the pressing tool with the larger elevation 11′ at least partially an entire removal of printing ink 5 occurs so that in this location an area is formed in which the surface 4 to be imprinted is no longer covered by printing ink 5″ and thus the primary colour of the surface 4 to be imprinted becomes visible. In the area of the pressing tool section with minor elevation 11 it is visible that printing ink 5 escapes towards the outside but only colour saturation decreases in this area so that a certain amount of printing ink 5 continues to cover the surface to be imprinted in this location. By this a certain shade of grey may be generated, if the printing ink 5 is black and the primary colour of the surface to be imprinted is white. But likewise also other mixed colour shades can be generated depending on the printing ink and primary colour used of the surface to be imprinted and on the colour saturation influenced by the structure of the pressing tool 10. Simultaneously with the application of pressure by pressing tool 10 heat is applied onto the surface element so that the wear protection layer can harden and the printing ink 5, 5′, 5″ is fixed.

In FIG. 1f the pressing tool 10 is removed. On the surface element 1, in particular on the wear protection layer 6 a structural pattern 7 exists comprising structural pattern sections with recesses 8 and structural pattern sections with elevations 9. It can be seen that the different colour saturation areas already mentioned with respect to FIG. 1e now locally match with the different structural pattern sections 8, 9.

The process described with respect to FIG. 2 in a second embodiment largely corresponds to the process which is shown with respect to FIG. 1. Insofar only the differences will be treated.

In FIG. 2b it can be seen that the surface 4 to be imprinted is substantially homogeneously wetted by printing ink 5, which may also be a pigmented resin or a film, fiber matrix or material treated with a pigmented resin. In FIG. 2e it can be seen that in the areas of surface element 1 cooperating with pressing tool sections with elevations 11, 11′ the printing ink 5 can escape towards the outside as has already been explained with respect to FIG. 1. In the areas of the surface element cooperating with the pressing tool section with recesses 12 no printing ink 5 escapes. Rather, in border areas between the pressing tool section with elevation 11 and the pressing tool section with recess 12 printing ink 5 is absorbed which in the area of the pressing tool sections with elevation 11 escaped laterally.

The substrates (i.e. the surface element) and products made from such substrates of the invention are typically used in the construction of a surface, such as a top for a counter or table, floor, ceiling or wall. Such surfaces are often found in residential structures (e.g., single and multifamily houses, condominiums, townhomes, co-operatives, apartments, and lobbies of such buildings), commercial structures (e.g., retail stores, strip malls, shopping malls, office buildings, hotels, restaurants, supermarkets, banks, churches, airports and other transit stations), public structures (e.g., stadiums and arenas, schools, museums, theaters, post offices, hospitals, courthouses and other government buildings), as well as industrial structures (e.g., manufacturing plants, mills, and warehouses) and surfaces of vehicles (e.g., ships, trains, aircraft, public and private busses, cars and other motor vehicles).

### LIST OF REFERENCE NUMERALS

1 surface element
2 supporting core
3 intermediate layer
4 surface to be imprinted
5 printing ink
6 wear protection layer
7 structural pattern
8 structural pattern section with recess
9 structural pattern section with elevation
10 pressing tool
11 pressing tool section with elevation
12 pressing tool section with recess

1. Method for manufacturing a surface element (1) with a supporting core (2) and a surface (4) to be imprinted comprising the following steps:
Impregnating the surface (4) to be imprinted with a dyed resin or application of priming ink (5) onto the surface (4) to be imprinted for creation of a decorative pattern,
attaching a pressing tool (10) and application of pressure onto the surface element (6),
wherein
as a function of a structure (11, 12) of the pressing tool (10), the printing ink (5) or the dyed resin is redistributed alongside the surface (4) to be imprinted, so that a colour saturation at least of areas of the decorative pattern is influenced.

2. Method according to claim 1, further comprising applying the printing ink (5) or the dyed resin is applied in a defined way on separate areas of the surface (4) to be imprinted with the decorative pattern in individual areas of the surface (4) to be imprinted being selectively influenced by the redistribution of the printing ink (5) or the dyed resin.

3. Method according to claim 1, further comprising applying the printing ink (5) or the dyed resin is applied onto the surface (4) to be imprinted substantially homogeneously, and the decorative pattern is exclusively created by redistribution of printing ink (5) or the dyed resin.

4. Method according to claim 1, further comprising applying a wear protection layer (6) on the surface (4) to be imprinted and on the printing ink (5) or the dyed resin applied.

5. Method according to claim 1, further comprising applying the printing ink (5) or the dyed resin directly onto the surface (4) to be imprinted.

6. Method according to claim 1, wherein the printing ink (5) or dyed resin is substantially free from binders.

7. Method according to claim 1, wherein the pressing tool (10) comprises pressing tool sections with elevations (11) and pressing tool sections with recesses (12) with the pressing tool sections with elevations (11) being able to create an defined escape of printing ink (5) or dyed resin on corresponding areas of the surface (4) to be imprinted alongside the surface (4) to be imprinted.

8. Method according to claim 1, wherein the pressing tool sections with recesses (12) can produce a minor escape of printing ink (5) or dyed resin on corresponding areas of the surface (4) to be imprinted than pressing tool sections with elevations (11) or can produce an accommodation of printing ink (5) or the dyed resin escaped in other areas of the surface (4) to be imprinted.

9. Method according to claim 1, wherein local fixation of the printing ink (5) or the dyed resin on the surface to be imprinted occurs exclusively in connection with the application of heat and/or pressure.

10. Surface element (1) comprising a supporting core (2), a surface (4) to be imprinted, which is at least indirectly applied onto the supporting core (2), with a decorative pattern being applied onto the surface (4) to be imprinted with at least one printing ink (5) or dyed resin, wherein the surface (4) to be imprinted is non-absorbing with respect to the printing ink or the dyed resin.

11. Surface element (1) according to claim 10, wherein the printing ink (5) or the dyed resin is displaced by pressure alongside the surface (4) to be imprinted.

12. Surface element (1) according to claim 10, wherein a structural pattern (7) is pressed onto the surface element (1) with substantially a lower colour saturation of the printing ink (5) or the dyed resin existing in areas of structural pattern sections with recesses (8) than in areas of structural pattern sections with elevations (9).

13. Surface element (1) according to claim 10, wherein the surface (4) to be imprinted is formed from glass, graphite, plastics or fibers therefrom.

14. Surface element (1) according to claim 10, wherein the decorative pattern is bicoloured with a first decorative colour being defined by a primary colour of the surface (4) to be imprinted, and a second decorative colour being defined by the printing ink (5) or the dyed resin.

15. Surface element (1) according to claim 10, wherein the decorative pattern is three-coloured or multi-coloured with a first decorative colour being defined by a primary colour of the surface (4) to be im-printed, and at least a second and a third decorative colour being defined by different printing inks (5, 5′, 5″) or dyed resins.
